(19) United States
(12) Patent Application Publication
(10) Pub. No.: US 2016/0003665 A1
(43) Pub. Date: Jan. 7, 2016

(54) SYSTEM AND METHOD TO AUTOMATICALLY SELF-ADJUST A VALVE PEDESTAL OF A MASS FLOW CONTROLLER

(71) Applicant: ILLINOIS TOOL WORKS INC., Glenview, IL (US)

(72) Inventors: William S. VALENTINE, Irvine, CA (US); Christophe ELLEC, Corona, CA (US)

(21) Appl. No.: 14/772,423

(22) PCT Filed: Feb. 22, 2014
(86) PCT No.: PCT/US2014/017859

§ 371 Date: Sep. 3, 2015

Related U.S. Application Data
(60) Provisional application No. 61/783,346, filed on Mar. 14, 2013.

(51) Int. Cl. G01F 25/00; G01F 15/00

(52) U.S. Cl. CPC G01F 25/00; G01F 15/005

(57) ABSTRACT

The disclosed embodiments include a method for improving a mass flow controller. In one embodiment, the method comprising the mass flow controller executing instructions, using at least one processing component, to perform operations comprising monitoring flow during an initial response of a setpoint change from zero to non zero; determining whether a valve response fits within an allowable limit; and automatically performing a self-adjustment to correct for the valve response in response to a determination that the valve response does not fit within the allowable limit

### BACKGROUND OF THE INVENTION

1. Field of the Invention

The present invention relates generally to the operation of a mass flow controller (MFC).

2. Discussion of the Related Art

Many industrial processes require precise control of various process fluids. For example, in the semiconductor industries, mass flow controllers are used to precisely measure and control the amount of a process fluid that is introduced to a process chamber. The term fluid is used herein to describe any type of matter in any state that is capable of flow. For example, it is to be understood that the term fluid may apply to liquids, gases, vapors, and slurries comprising any combination of matter or substance to which controlled flow may be of interest.

MFC customers often monitor the turn-on characteristics as a quality and performance metric (e.g., the time it takes to reach the setpoint and the amount of overshoot). Typically no overshoot is allowed.

Customers want repeatability from device to device. To ensure that an MFC behaves correctly, the MFC is tuned. Tuning is the process by which a specific MFC characteristic is calibrated so that each device may provide the same behavior when subjected to the same inputs. For example, when given a particular setpoint, all MFCs are expected to reach that setpoint within a certain amount of time (e.g., 300 ms +/−50 ms). It would not be of interest for the customer to get MFCs that are as fast as possible if one of them reaches setpoint in 150 ms and another in 400 ms.

Tuning an MFC is a difficult operation that requires specialized setup and experienced operators. In addition, changes in the operating conditions and slight changes in the physical characteristics of the MFC can require expensive field service to retune the device after a few months of operation.

Accordingly, the disclosed inventions seek to provide one or more solutions to the above problems. For instance, in one embodiment, the disclosed inventions include an MFC that is configured to execute an algorithm for monitoring the turn-on response characteristics and automatically self-adjust the tuning parameters.

### BRIEF DESCRIPTION OF THE DRAWINGS

Illustrative embodiments of the present invention are described in detail below with reference to the attached figures, which are incorporated by reference herein and wherein:

FIG. 1 is a diagram that illustrates components of a mass flow controller in accordance with the disclosed embodiments;

FIG. 2 is a graph illustrating an example an initial tuning and stress cycle in accordance with the disclosed embodiments;

FIG. 3A is a flow chart depicting a process for automatically self-adjusting the tuning parameters in accordance with the disclosed embodiments;

FIG. 3B is a flow chart depicting an alternative embodiment of a process for automatically self-adjusting the tuning parameters in accordance with the disclosed embodiments; and

FIG. 4 is a block diagram that depicts a modified control algorithm that is executed in a mass flow controller in accordance with the disclosed embodiments.

### DETAILED DESCRIPTION

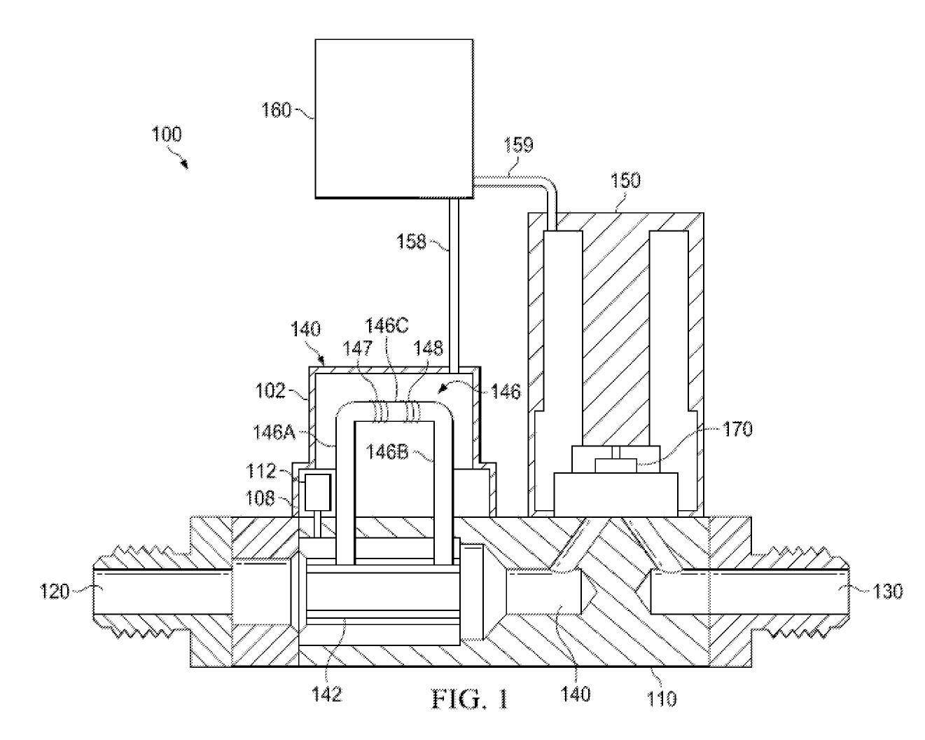

The disclosed embodiments and advantages thereof are best understood by referring to FIGS. 1-4 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 illustrates components of a mass flow controller 100 in accordance with the disclosed embodiments. In one embodiment, mass flow controller 100 includes a block 110, which is the platform on which the components of the mass flow controller are mounted. A thermal mass flow meter 140 and a valve assembly 150 are mounted on the block 110 between a fluid inlet 120 and a fluid outlet 130. In other embodiments, the thermal mass flow meter 140 may be bolted directly to the valve assembly 150 without the use of the block 110. The valve assembly 150 includes a control valve 170. In certain embodiments, the control valve 170 may be one of a solenoid valve or a Piezo valve. The thermal mass flow meter 140 includes a bypass 142 through which typically a majority of fluid flows and a thermal flow sensor 146 through which a smaller portion of the fluid flows.

Thermal flow sensor 146 is contained within a sensor housing 102 (portion shown removed to show sensor 146) mounted on a mounting plate or base 108. Sensor 146 is a small diameter tube, typically referred to as a capillary tube, with a sensor inlet portion 146A, a sensor outlet portion 146B, and a sensor measuring portion 146C about which two resistive coils or windings 147, 148 are disposed. In operation, electrical current is provided to the two resistive windings 147, 148, which are in thermal contact with the sensor measuring portion 146C. The current in the resistive windings 147, 148 heats the fluid flowing in measuring portion 146 to a temperature above that of the fluid flowing through the bypass 142. The resistance of windings 147, 148 varies with temperature. As fluid flows through the sensor conduit, heat is carried from the upstream resistor 147 toward the downstream resistor 148, with the temperature difference being proportional to the mass flow rate through the sensor.

An electrical signal related to the fluid flow through the sensor is derived from the two resistive windings 147,148. The electrical signal may be derived in a number of different ways, such as from the difference in the resistance of the resistive windings or from a difference in the amount of energy provided to each resistive winding to maintain each winding at a particular temperature. Examples of various ways in which an electrical signal correlating to the flow rate of a fluid in a thermal mass flow meter may be determined are described, for example, in commonly owned U.S. Pat. No. 6,845,659, which is hereby incorporated by reference. The electrical signals derived from the resistive windings 147,148 after signal processing comprise a sensor output signal.

The sensor output signal is correlated to mass flow in the mass flow meter so that the fluid flow can be determined when the electrical signal is measured. The sensor output signal is typically first correlated to the flow in sensor 146, which is then correlated to the mass flow in the bypass 142, so that the total flow through the flow meter can be determined and the control valve 170 can be controlled accordingly. The correlation between the sensor output signal and the fluid flow is complex and depends on a number of operating conditions including fluid species, flow rate, inlet and/or outlet pressure, temperature, etc.

A bypass 142 may then be mounted to the sensor, and the bypass 142 is tuned with the known fluid to determine an appropriate relationship between fluid flowing in the mass flow sensor and the fluid flowing in the bypass at various known flow rates, so that the total flow through the flow meter can be determined from the sensor output signal. In some mass flow controllers, no bypass is used, and the entire flow passes through the sensor. The mass flow sensor portion and bypass 142 may then be mated to the control valve and control electronics portions and then tuned again, under known conditions. The responses of the control electronics and the control valve are then characterized so that the overall response of the system to a change in set point or input pressure is known, and the response can be used to control the system to provide the desired response.

In addition, the mass flow controller 100 may include a pressure transducer 112 coupled to flow path at some point, typically, but not limited to, upstream of the bypass 142 to measure pressure in the flow path. Pressure transducer 112 provides a pressure signal indicative of the pressure.

Control electronics 160 is used to control the position of the control valve 170 in accordance with a set point indicating the desired mass flow rate, and an electrical flow signal from the mass flow sensor indicative of the actual mass flow rate of the fluid flowing in the sensor conduit. In certain embodiments, traditional feedback control methods such as proportional control, integral control, proportional-integral (PI) control, derivative control, proportional-derivative (PD) control, integral-derivative (ID) control, and proportional-integral-derivative (PID) control are then used to control the flow of fluid in the mass flow controller. Other embodiments may employ a model based controller that does not use any PID type control. A control signal (e.g., a control valve drive signal) is generated based upon an error signal that is the difference between a set point signal indicative of the desired mass flow rate of the fluid and a feedback signal that is related to the actual mass flow rate sensed by the mass flow sensor. The control valve is positioned in the main fluid flow path (typically downstream of the bypass and mass flow sensor) and can be controlled (e.g., opened or closed) to vary the mass flow rate of fluid flowing through the main fluid flow path, the control being provided by the mass flow controller.

In the illustrated example, the flow rate is supplied by electrical conductors 158 to a closed loop system controller 160 as a voltage signal. The signal is amplified, processed and supplied using electrical conductors 159 to the valve assembly 150 to modify the flow. To this end, the controller 160 compares the signal from the mass flow sensor 140 to predetermined values and adjusts the control valve 170 accordingly to achieve the desired flow.

Although FIG. 1 depicts that the mass flow controller 100 includes a thermal mass flow sensor, the mass flow controller 100, in accordance with the disclosed embodiments, may utilize other types of mass flow sensors including a Coriolis type sensor or a differential pressure type sensor. An advantage of using a Coriolis-based sensor is that it is capable of determining mass flow independent of temperature, flow profile, density, viscosity, and homogeneity. Additionally, differential pressure type sensors are becoming popular for gas control.

Additionally, while the above description of the mass flow controller 100 discloses the use of voltage signals, in certain embodiments, the mass flow controller 100 may include distributed electronics where the signals will be digital commands to and from the sensor and to and from the valve.

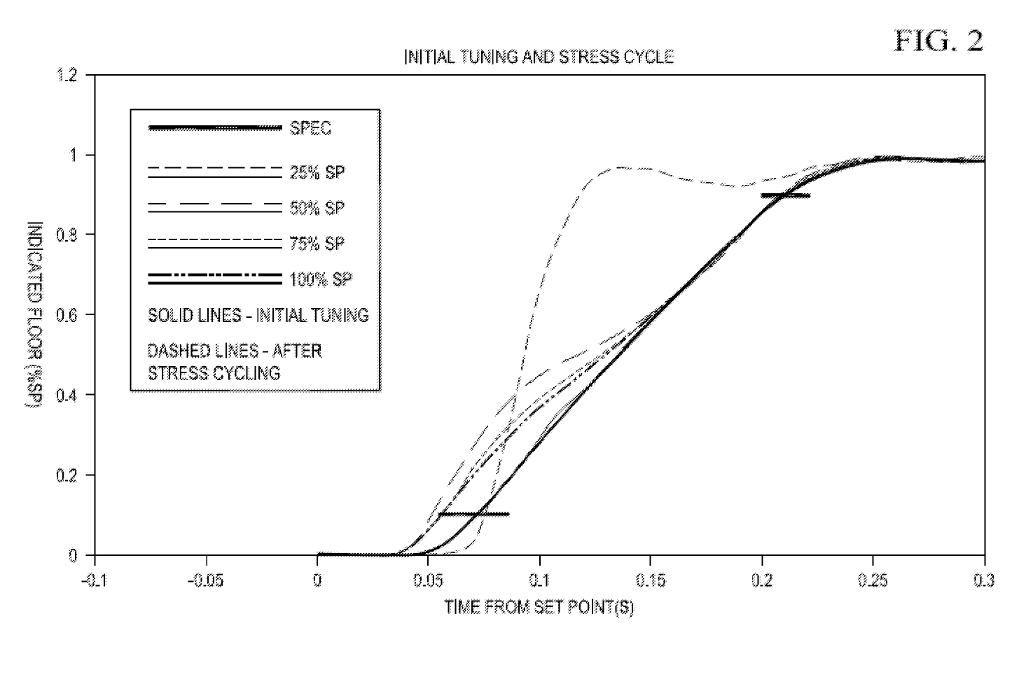

FIG. 2 depicts an example of a graph illustrating an initial tuning and stress cycle. As illustrated in FIG. 2, a device is tuned so its response from the factory (solid lines) passes within the horizontal black lines that represent the allowable limits. Over time, the response of the device changes so that the new response (dashed lines) does not fall within the limits anymore. Currently, this is monitored by the customer who then will either return the units to the factory or request a field service technician to come and fix the MFC. Either action is time consuming, costly and results in customer dissatisfaction.

In addition, the response characteristics is gas specific, but the tuning is typically done only on one gas at the factory then again at the customer site if a different gas requires drastic changes in tuning. One current work around for the change over time is to subject the valve to extensive cycling at the factory after tuning, then validate, then retune as necessary and cycle again. However, this is time consuming and is a non value added process.

Accordingly, as stated above, the disclosed inventions provide an MFC that executes an algorithm to monitor the turn-on response characteristics and automatically self-adjust the tuning parameters.

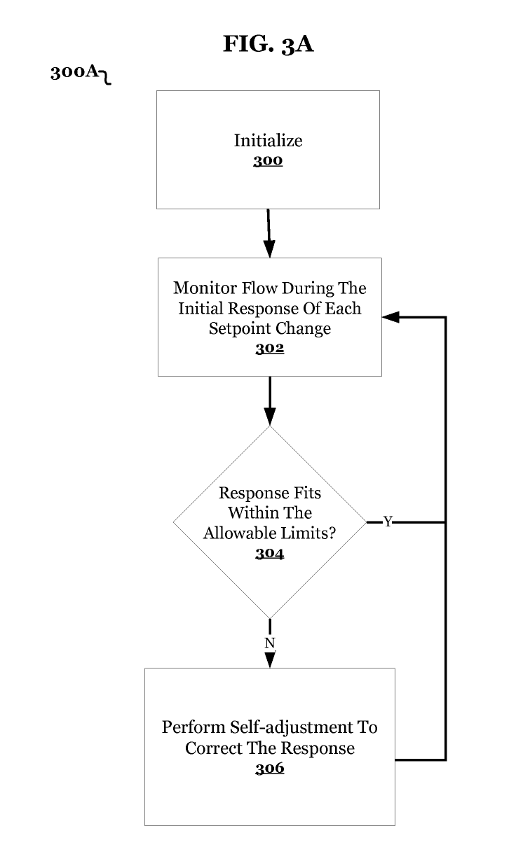

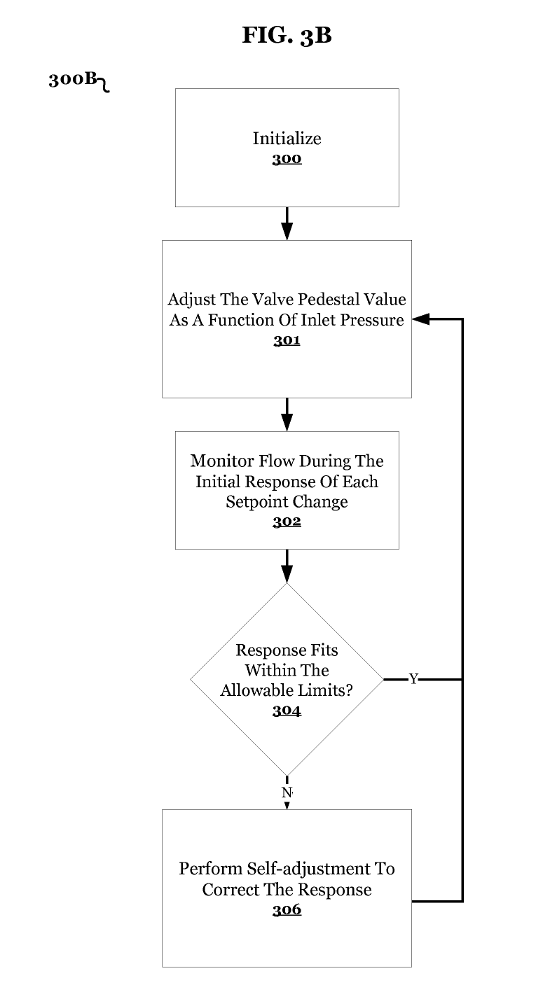

For example, FIG. 3A depicts a process 300A for automatically self-adjusting the tuning parameters such as, but not limited to, a valve pedestal value, for correcting a valve response of a MFC due to changes that occur over time and/or alternatively, due to a change in inlet pressure. The valve pedestal value is the amount of displacement the valve first moves after receiving a non-zero setpoint. It is like a first step move to avoid a long delay in the valve opening. The valve pedestal value is typically set at tuning to the highest possible value that can provide a quick response without overshoot. Setting the value too high will cause the valve to “jump the gun” and create an overshoot as the valve moves too far too fast. In addition, the pedestal parameter is highly sensitive to the inlet pressure and gas characteristics. Additionally, over time, the tuning parameters may require adjustment due to changes in the operating conditions and slight changes in the physical characteristics of the control valve.

In accordance with one embodiment, a MFC as described above is initially tuned so its response from the factory is within allowable limits in accordance with the below equation:

Pedestal=P_{factory} (Equation 1)

Where P_{factory} is a constant determined at the factory.

The process 300A, at step 300, begins by initializing the MFC during power up or during a change of gas to reload pertinent attributes from memory. The process 300A then monitors the flow during the initial response of each setpoint change from zero to non zero (block 302) and measuring/determining whether the response fits within the allowable limits (block 304). For example, in one embodiment, one measured value is the time to reach X% of the final setpoint (X typically 10%-20%, t20) and another measured value is the time to reach Y% of the final setpoint (Y typically 75%-95%, t₉₅). In certain embodiments, the disclosed embodiments could monitor the whole curve for fit against a nominal curve as opposed to only looking at t20 and t95.

Still, in some embodiments, a third measured value is the value of the overshoot the first time the flow passes the requested setpoint (ovs). That value can be 100% to 125% of the final setpoint, but could be over 200% when the tuning is really poor.

If the response fits within the allowable limits, the process returns to step 302. However, if the response does not fit within the allowable limits, the process automatically performs a self-adjustment to correct for the response (block 306). For example, in one embodiment, the process may be configured to execute instructions to correct the response by adjusting the P, I and D parameters of the control loop.

Alternatively, the process may be configured to execute instructions to correct the response by adjusting the pedestal parameters such as, but not limited to, adjusting the pedestal correction value. For instance, as shown in FIG. 2, the response characteristics may slowly evolve over time to the point where the response curves do not fall within the acceptable limit In one embodiment, the algorithm will correct this degradation by adjusting the pedestal as a function of inlet pressure, for example, based on the following equations:

Ped_{corrected}=Pedestal*(1+P_{correctionfactor}) (Equation 2)

Pedestal=Pr_{actual}*(Ped_{high}−Ped_{low})/(Pr_{high}−Pr_{low})+Pr0 (Equation 3)

Or

Pedestal=Pr0+Pr1*Practual+Pr2*Practual²+ . . . +Prn*Practualⁿ (Equation 4)

where Pr0 . . . Prn are constants determined during tuning process;

Pr_{actual} is the pressure measured by pressure transducer 112;

Ped_{high}, Ped_{low} are the respective pedestal values obtained at high and low pressure during the factory tuning process; and

P_{correctionfactor} is adjusted iteratively after each setpoint change. If the response is outside on the too fast side, the correction factor is decremented by a small amount. If the response is outside on the too slow side, the correction factor is incremented by a small amount. The correction factor can be positive or negative. The amount of correction may be adjustable. Since the goal is to adjust at every step, the amount of correction is typically very small but additive over time, so as not to introduce any sudden changes to the process. The total amount of correction allowable may be adjustable. Alarms may be implemented based on some correction threshold.

Similar corrections may be implemented for the P, I D parameters in block 306, with respective amount of correction, limits and thresholds.

All the correction factors may be saved in flash memory after a certain amount of time or a certain level of correction so that after a power cycle the device continues the correction from the last saved value instead of starting from 0. Additionally, all the correction factors may be saved as gas dependent values so that if the customer changes gas periodically to accommodate their processes requirements, the correction for each gas is separate from the corrections for another gas.

FIG. 3B depicts an alternative embodiment (process 300B) for automatically self-adjusting the tuning parameters. In contrast to FIG. 3A, in this embodiment, the process reads inlet pressure and corrects the pedestal based on inlet pressure (step 301) after initializing the MFC at power up or after a change of gas to reload pertinent attributes from memory (step 300). The process then monitors the MFC response (step 302) and further adjusts tuning parameters (step 306) such as pedestal if the response is out of acceptable limits (step 304) as described above.

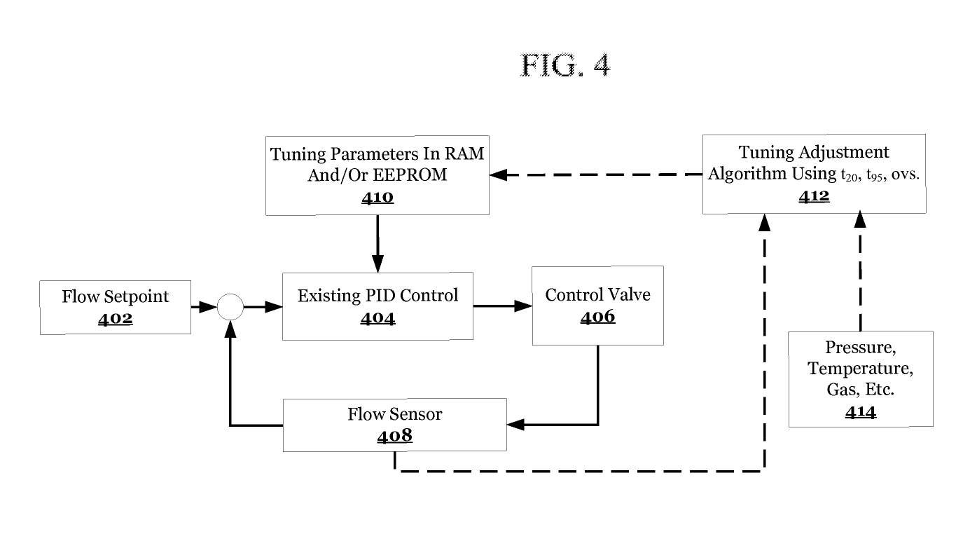

FIG. 4 depicts a modified control algorithm that is executed in a MFC in accordance with a disclosed embodiment. The solid black lines represent the existing control algorithm of a MFC. For instance, in the existing control algorithm, a PID controller 404 receives a flow setpoint 402 and based on tuning parameter stored in memory (e.g., Random-Access Memory (RAM) or Electrically Erasable Programmable Read-Only Memory (EEPROM)), the PID controller 404 adjusts a control valve 406. The fluid flow is then measured using a flow sensor 408. The flow measurement is relayed to the PID controller 404, which re-adjusts the control valve if necessary for controlling fluid flow.

In accordance with the disclosed embodiments, the dash lines in FIG. 4 indicate the modification to the existing control algorithm. Based on the flow measurement, the modified control algorithm executes at block 412 the tuning adjustment algorithm as described above, in which the pressure, temperature, gas type, or other parameters 414, are used to update the tuning parameters 410 to automatically adjust the valve pedestal. In certain embodiments, limits can be set within the new algorithm for the amount of change allowable over a certain time period, the total amount of change allowed, how to report the amount of change made, how to report various errors, etc.

Accordingly, the disclosed inventions provide various embodiments for providing a mass flow controller configured to automatically self-adjust the tuning parameters. While specific details about the above embodiments have been described, the above descriptions are intended merely as example embodiments and are not intended to limit the structure or implementation of the disclosed embodiments.

Those skilled in the art will recognize that the present teachings are amenable to a variety of modifications and/or enhancements. While the foregoing has described what is considered to be the best mode and/or other examples, it is understood that various modifications may be made therein and that the subject matter disclosed herein may be implemented in various forms and examples, and that the teachings may be applied in numerous applications, only some of which have been described herein. Such modifications are intended to be covered within the true scope of the present teachings.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to explain the principles of the invention and the practical application, and to enable others of ordinary skill in the art to understand the invention for various embodiments with various modifications as are suited to the particular use contemplated. The scope of the claims is intended to broadly cover the disclosed embodiments and any such modification.

1. A method for improving a mass flow controller, the method comprising the mass flow controller executing instructions, using a processor, to perform operations comprising:
monitoring flow during an initial response of a setpoint change from zero to non zero;
determining whether a valve response fits within an allowable limit; and
automatically performing a self-adjustment to correct for the valve response in response to a determination that the valve response does not fit within the allowable limit.

2. The method of claim 1, wherein the self-adjustment to correct for the valve response comprises adjusting proportional, integral, and derivative (PID) parameters of a control loop.

3. The method of claim 1, wherein the self-adjustment to correct for the valve response comprises adjusting pedestal parameters to correct for changes that occur over time.

4. The method of claim 1, wherein the self-adjustment to correct for the valve response comprises adjusting a pedestal as a function of inlet pressure.

5. The method of claim 4, wherein adjusting the valve pedestal value as a function of inlet pressure is determined as follows:
Pedestal=Pr_{actual}*(Ped_{high}−Ped_{low})/(Pr_{high}−Pr_{low})+Pr0, where Pr_{actual} is a measured pressure, Ped_{high}, Ped_{low} are respective pedestal values obtained at high and low pressure during a factory tuning process, and Pr0 is a constant determined at an end of the factory tuning process.

6. The method of claim 1, wherein determining whether the valve response fits within the allowable limit comprises:
determining a first measured value to reach a first percentage of a final setpoint; and
determining a second measured value to reach a second percentage of the final setpoint.

7. The method of claim 6, wherein determining whether the valve response fits within the allowable limit further comprises:
determining a third measured value of an overshoot that occurs a first time the flow passes the final setpoint.

8. The method of claim 3, wherein adjusting pedestal parameters is performed as follows:
Ped_{corrected}=Pedestal*(1+P_{correctionfactor}),
wherein Pedestal=Pr_{actual}*(Ped_{high}−Ped_{low})/(Pr_{high}−Pr_{low})+Pr0, where Pr_{actual} is a measured pressure, Ped_{high}, Ped_{low} are respective pedestal values obtained at high and low pressure during a factory tuning process, and Pr0 is a constant determined at an end of the factory tuning process, and
wherein P_{correctionfactor} is adjusted iteratively after the setpoint change, where if the valve response is too fast, the P_{correctionfactor} is decremented by a small amount, and if the response is too slow, the P_{correctionfactor} is incremented by a small amount.

9. The method of claim 8, wherein the pedestal parameters are saved in memory.

10. The method of claim 9, wherein the mass flow controller is further configured to execute instructions, using the processor, to continue performing a correction after a power cycle based on the pedestal parameters saved in memory.

11. A mass flow controller comprising:
an inlet for receiving fluid;
a flow path in which the fluid passes through the mass flow controller;
a mass flow sensor for providing a signal corresponding to mass flow of the fluid through the flow path;
an valve for regulating a flow of the fluid out of an outlet of the mass flow controller; and
at least one processing component configured to execute instructions to perform operations comprising:
monitoring flow during an initial response of a setpoint change from zero to non zero;
determining whether a valve response fits within an allowable limit; and
automatically performing a self-adjustment to correct for the valve response in response to a determination that the valve response does not fit within the allowable limit.

12. The mass flow controller of claim 11, wherein the self-adjustment to correct for the valve response comprises adjusting proportional, integral, and derivative (PID) parameters of a control loop.

13. The mass flow controller of claim 11, wherein the self-adjustment to correct for the valve response comprises adjusting pedestal parameters to correct for changes that occur over time.

14. The mass flow controller of claim 11, wherein the self-adjustment to correct for the valve response comprises adjusting a pedestal as a function of inlet pressure.

15. The mass flow controller of claim 14, wherein adjusting the valve pedestal value as a function of inlet pressure is determined as follows:
Pedestal=Pr_{actual}*(Ped_{high}−Ped_{low})/(Pr_{high}−Pr_{low})+Pr0, where Pr_{actual} is a measured pressure, Ped_{high}, Ped_{low} are respective pedestal values obtained at high and low pressure during a factory tuning process, and Pr0 is a constant determined at an end of the factory tuning process.

16. The mass flow controller of claim 11, wherein determining whether the valve response fits within the allowable limit comprises:
determining a first measured value to reach a first percentage of a final setpoint; and
determining a second measured value to reach a second percentage of the final setpoint.

17. The mass flow controller of claim 16, wherein determining whether the valve response fits within the allowable limit further comprises:
determining a third measured value of an overshoot that occurs a first time the flow passes the final setpoint.

18. The mass flow controller of claim 13, wherein adjusting pedestal parameters is performed as follows:
Ped_{corrected}=Pedestal*(1+P_{correctionfactor}),
wherein Pedestal=Pr_{actual}*(Ped_{high}−Ped_{low})/(Pr_{high}−Pr_{low})+Pr0, where Pr_{actual} is a measured pressure, Ped_{high}, Ped_{low} are respective pedestal values obtained at high and low pressure during a factory tuning process, and Pr0 is a constant determined at an end of the factory tuning process, and
wherein P_{correctionfactor} is adjusted iteratively after the setpoint change, where if the valve response is too fast, the P_{correctionfactor} is decremented by a small amount, and if the response is too slow, the P_{correctionfactor} is incremented by a small amount.

19. The mass flow controller of claim 18, wherein the pedestal parameters are saved in memory.

20. A method for improving a mass flow controller, the method comprising the mass flow controller executing instructions, using a processor, to perform operations comprising:
adjusting a pedestal as a function of inlet pressure;
monitoring flow during an initial response of a setpoint change from zero to non zero;
determining whether a valve response fits within an allowable limit;
automatically performing a self-adjustment to correct for the valve response in response to a determination that the valve response does not fit within the allowable limit.
